(19) United States
(12) Patent Application Publication
(10) Pub. No.: US 2026/0346563 A1
(43) Pub. Date: Nov. 5, 2026

(54) MULTILAYER HOSE WITH NITRILE RUBBER ADHERED TO POLYKETONE BARRIER LAYER

(71) Applicant: ContiTech Deutschland GmbH, Hannover (DE)

(72) Inventors: Heath Harris, Akron, OH (US); Thomas George Burrowes, North Canton, OH (US)

(73) Assignee: ContiTech Deutschland GmbH, Hannover (DE)

(21) Appl. No.: 19/196,286

(22) Filed: May 1, 2025

(51) Int. Cl. B32B 1/08; B32B 7/10; B32B 25/04; B32B 25/08; B32B 25/10; B32B 37/00; B32B 37/15

(52) U.S. Cl. CPC B32B 1/08; B32B 7/10; B32B 25/042; B32B 25/08; B32B 25/10; B32B 37/153; B32B 2037/0092; B32B 2250/04; B32B 2255/10; B32B 2270/00; B32B 2307/51; B32B 2307/54; B32B 2307/714; B32B 2307/7265; B32B 2319/00; B32B 2327/06; B32B 2355/00; B32B 2386/00; B32B 2597/00

(57) ABSTRACT

A multilayer permeation resistant article, such as a fuel transfer hose, includes an NBR elastomeric layer and a polyketone (PK) barrier layer. The elastomeric layer may be directly bonded to the PK barrier layer without an intervening adhesive layer. To facilitate such direct bonding, the elastomeric layer may be formed from a composition including nitrile rubber(s), ethylene vinyl acetate elastomer(s) (EVM), and polyvinylchloride(s) (PVC). The composition includes the NBR(s) in a major amount. The EVM(s) and PVC(s) may be present in a bond effective amount to bond to the PK barrier layer, and an effective amount to reduce at least volumetric swell when immersed in fuel. The EVM(s) may be present in a total amount from 5 phr to 15 phr; and the PVC(s) may be present in a total amount from 10 phr to 20 phr to provide such bonding to the PK barrier layer and reduce volumetric swell.

### TECHNICAL FIELD

The present disclosure relates generally to an article having a nitrile rubber layer adhered to a polyketone barrier layer that provides low permeation, particularly of hydrocarbon fuel, and more particularly to a multilayer reinforced hose having such adhesion of the nitrile rubber to the polyketone barrier layer for low permeation applications such as a fuel transfer hose.

### BACKGROUND

Thermoplastic and rubber hoses are used in a wide variety of applications for transporting fluids such as liquids and gases. For example, one common application of a multilayer hose is as a fuel pump hose (also referred to as a curb pump hose) that is used to transfer fuel from a storage tank to a vehicle at the pump. Generally, a fuel transfer hose should be strong, durable, flexible, resistant to organic solvents, resistant to volumetric expansion, offer a long service life, and have low permeability to gasoline, gasohol, diesel, biodiesel, avgas, jet fuel, or the like. Such fuel hoses also should be capable of being coupled to fittings in a manner that prevents fuel from escaping.

### SUMMARY

One conventional approach for a fuel transfer hose is to provide an inner tube of elastomeric material, a permeation resistant barrier layer, a reinforcement layer, and an elastomeric cover layer. To provide low permeability to fuel, the barrier layer often is formed from a thermoplastic fluoropolymer, such as THV (tetrafluoroethylene-hexafluoropropylene-vinylidene fluoride). Due at least to limited supply of THV, however, there is a need in the market for hoses, and permeation resistant articles in general, to replace THV with other suitable barrier material.

At least one aspect of the present disclosure solves one or more problems associated with conventional permeation resistant articles containing conventional barrier layers such as THV.

According to at least one aspect, the present disclosure provides a permeation resistant article having a polyketone (PK) barrier layer directly bonded to a nitrile butadiene rubber (NBR) elastomeric layer without an intervening adhesive layer.

Such direct bonding can obviate problems associated with adhesive layers, such as the release of volatile organic compounds which can become trapped as bubbles between layers and/or which can be applied inconsistently, each of which can result in spotty adhesion between layers.

In exemplary embodiments, the NBR elastomeric layer includes ethylene vinyl acetate elastomer (EVM), which was found to serve as an adhesion promoter for the direct bonding to the PK barrier layer.

In exemplary embodiments, the NBR elastomeric layer also includes polyvinyl chloride (PVC) in addition to the EVM, which the PVC also was found to serve as an adhesion promoter for the direct bonding to the PK barrier layer.

In exemplary embodiments, the bonding performance of the NBR elastomeric layer to the PK barrier layer may be characterized by an average load per width of 10 lbf/in or greater according to ASTM D413-98, more particularly about 15 lbf/in or greater which may result in stock tear of the rubber material.

In exemplary embodiments, the permeation resistance of the article may be characterized by a permeation rate of less than 10 g/m²/day, more particularly less than 5 g/m²/day, or even more particularly less than 1 g/m²/day.

In exemplary embodiments, the permeation resistant article is a flexible article, such as a hose, more particularly a fuel transfer hose.

According to an aspect, a multilayer hose includes: an NBR elastomeric layer directly bonded to a polyketone (PK) barrier layer without an intervening adhesive layer, the NBR elastomeric layer formed from a composition comprising: one or more nitrile butadiene elastomer(s) (NBR) in a total amount from 50 phr to 100 phr, more particularly from 80 phr to 100 phr; one or more ethylene-vinyl acetate elastomer(s) (EVM) in a total amount from 5 phr to 15 phr; and one or more polyvinylchloride polymer(s) (PVC) in a total amount from 10 phr to 20 phr.

According to another aspect, a method of producing such a multilayer article includes: extruding the NBR elastomeric layer; extruding the PK barrier layer; wherein the NBR elastomeric layer and the PK barrier layer are in direct contact without an intervening adhesive layer; activating the cure system by increasing temperature; crosslinking the NBR elastomeric layer and directly bonding the NBR elastomeric layer to the PK barrier layer.

According to another aspect, a fuel system includes a source of hydrocarbon-based fuel, and the fuel transfer hose according to any of the foregoing fluidly connected to the source of fuel and configured to transfer the fuel.

According to another aspect, a method of using such a fuel transfer hose in a fuel system includes conveying liquid hydrocarbon fuel through the fuel hose.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various aspects according to the present disclosure.

FIG. 1 shows an exemplary embodiment of a hose according to the present disclosure.

FIG. 2 shows another exemplary embodiment of a hose according to the present disclosure.

FIG. 3 shows another exemplary embodiment of a hose according to the present disclosure.

FIG. 4 shows another exemplary embodiment of a hose according to the present disclosure.

FIG. 5 shows an exemplary embodiment of an article according to the present disclosure.

FIG. 6 shows another exemplary embodiment of an article according to the present disclosure.

FIG. 7 shows another exemplary embodiment of an article according to the present disclosure.

### DETAILED DESCRIPTION

The principles and aspects of the present disclosure have particular application to hoses, in particular fuel transfer hoses, and thus will be described herein chiefly in this context. It is understood, however, that the principles and aspects of the present disclosure may be applicable to other types of hoses for other applications, or to other articles in general, when desirable to provide one or more advantages of the material(s) and/or construction(s) described herein.

Many conventional permeation resistant articles such as fuel transfer hoses use conventional barrier material such as THV (tetrafluoroethylene-hexafluoropropylene-vinylidene fluoride). THV is not classified as a per- and polyfluoroalkyl substance (PFAS), commonly referred to as forever chemicals, but has allegedly been associated with PFAS due to its carbon-fluorine bonds. Thus, THV may be subject to similar regulatory scrutiny, impacting its availability and driving the need for alternative solutions.

Aspect(s) according to the present disclosure replace conventional barrier materials such as THV with a polyketone (PK) barrier layer that is directly bonded to at least one nitrile butadiene rubber (NBR) elastomeric layer without an intervening adhesive layer to thereby provide a flexible and permeation resistant article. Aspect(s) according to the present disclosure also provide a unique approach to using the combination of NBR and polyketone in a fuel transfer hose.

### Polyketone Barrier Layer

The PK barrier layer may be formed from an aliphatic polyketone material of formula [[—CHR₁CH₂(C═O)—]ₙ[—CHR₂CH₂(C═O)—]ₘ]_{P}. In the formula, R₁ and R₂ are different from each other and are independently hydrogen or a C₁-C₁₂-alkyl group, n+m=1, and p is an integer. The two comonomers may be randomly distributed or present as blocks.

In the specified aliphatic polyketone formula, if R₁ and/or R₂ is a C₁-C₁₂-alkyl group, the C₁-C₁₂-alkyl group may be selected from methyl, ethyl, propyl, pentyl or heptyl. In exemplary embodiments, R₁ may be a C₁-C₁₂-alkyl group such as a methyl group and R₂ is H. In certain embodiments, when R₁ is a C₁-C₁₂-alkyl group, “n” is preferably less than 0.5, in particular less than 0.1, and more particularly between 0.02 and 0.08. In another embodiment, n=0 and R₂ is H, in which the aliphatic polyketone is present as poly(ethylene ketone). “P” may be an integer between 500 and 5000, for example.

The aliphatic polyketone may have a weight-average molecular weight Mw of at least 40,000 g/mol, and in particular at least 60,000 g/mol. In certain embodiments, the aliphatic polyketone has a molecular weight of at least 200,000 g/mol. For example, the aliphatic polyketone may have a weight-average molecular weight Mw of 140,000 g/mol to 410,000 g/mol, more particularly a weight-average molecular weight of 150,000 g/mol to 210,000 g/mol or of 290,000 g/mol to 400,000 g/mol and even more particularly a weight-average molecular weight of from 160,000 g/mol to 200,000 g/mol or from 300,000 g/mol to 390,000 g/mol. The weight average molecular weight Mw can be determined by GPC using suitable standards.

The aliphatic polyketone may be semi-crystalline, which such crystallinity can be detected using DSC measurements of the polymer. The aliphatic polyketone polymer may contain at least 80% by volume, in particular at least 90% by volume, and particularly at least 95% by volume, of the structural units (1) and (11). Variations of the polyketone material may have different lengths, may have a linear chain or branched polymer chains and/or may have the presence of polar functional groups. The PK barrier layer may be formed from a single type of aliphatic polyketone material or may be formed from a mixture of different types of PK materials.

In certain embodiments, the aliphatic polyketone has a melting temperature between about 190 °C and about 250 °C, more particularly between about 200 °C to about 220 °C. The polyketone barrier layer can be processed by conventional techniques, for example, by extrusion.

In exemplary embodiments, the polyketone barrier layer may have a permeability of CE10 fuel characterized by a permeation rate of less than 15 g/m²/day, more particularly less than 10 g/m²/day, more particularly less than 5 g/m²/day, or even more particularly less than 1 g/m²/day. Such values may be based on SAE J2665 testing standard or corresponding testing at atmospheric conditions (e.g., about 25 °C and about 30 in·Hg).

Table 1 illustrates permeation results of polyketone barrier layer samples (PK-1 through PK-4) compared against THV barrier layer samples (THV-1 through THV-4) of a type currently used in conventional fuel hoses. The polyketone tested was extrusion grade POKETONE M710F from Hyosung. In the test, barrier layer material of about 0.5 mm for the polyketone and 0.25 mm for the THV is cut into a shape that fits over the mouth of a glass jar but fits inside a tightening ring used to seal the glass jar. 100 mL of CE10 fuel is placed into the glass jar. A FKM rubber gasket is placed on the jar rim, then the barrier material is placed on top the gasket, covering the opening to the jar. The tightening ring is used to push the whole assembly together to seal the jar. The assembly is weighed immediately after sealing and then subsequently in the days following to measure the weight loss after each interval which can be used to calculate permeation rate (fuel vapor loss). All testing is conducted at atmospheric conditions (e.g., room temperature (~25 °C)).

TABLE 1
Permeation Rate (g/m²/day)

| | 3 Day | 14 Day | 28 Day |
|---|---|---|---|
| PK-1 | 7.3 | 2.2 | 1.5 |
| PK-2 | 0.6 | 0.7 | 0.8 |
| PK-3 | 0.6 | 0.7 | 0.8 |
| PK-4 | 0.0 | 0.6 | 0.7 |
| THV-1 | 4.7 | 1.2 | 0.6 |
| THV-2 | 0.3 | 0.1 | 0.0 |
| THV-3 | 5.5 | 1.2 | 0.6 |
| THV-4 | 0.3 | 0.1 | 0.0 |

As shown in these test results, the PK barrier layer material exhibits permeation loss rates that are comparable to the conventional THV material, suggesting that the PK barrier layer is suitable for use as a barrier layer in a permeation resistant article such a fuel transfer hose. Although a variation of the standard SAE J2665 permeation rate test, these results are believed to be consistent with the SAE J2665 standard. In an article construction, such as a hose construction, the PK barrier layer in conjunction with other layers is expected to provide at least these permeation results.

In the context of its use in an article, such as a hose, it is understood that the aliphatic polyketone in the barrier layer may additionally contain one or more compounding additives to improve its processability and/or material properties. Such additives may be selected from one or more of reinforcing agents, antioxidants, heat stabilizers, ultraviolet absorbers, light stabilizers, lubricants, inorganic fillers, antistatic agents, flame retardants, accelerators, plasticizers, dyes, impact modifiers or the like. Alternatively, the barrier layer may consist essentially of pure (e.g., 95%+ or 99%+) aliphatic polyketone material(s) as described above, with no, or substantially no, compounding additives added to the PK composition. In exemplary embodiments, for example, the PK barrier layer does not contain elastomers or other adhesion promoters for bonding to the NBR elastomeric layer.

### NBR Elastomeric Layer

The nitrile butadiene rubber (NBR) elastomeric layer of the article generally provides flexibility and elasticity, and also can facilitate sealing of the article to restrict loss of the substance to be contained. Depending on the location in the article, the NBR elastomeric layer also can provide chemical resistance, permeation resistance, sealability, or various other functions. More particularly, the NBR elastomeric layer may be used as an inner tube layer and provide suitable properties when exposed to hydrocarbon fuel, such as suitable retained mechanical properties and suitable volumetric swell. Alternatively or additionally, the NBR elastomeric layer may be used as an intermediate layer and provide suitable adhesion properties for bonding to reinforcements, such as brass wire or the like, as described in further detail below.

The exemplary NBR elastomeric layer is formed from an elastomeric composition that includes one or more NBR base elastomers. According to at least one aspect, the NBR elastomeric composition further includes one or more adhesion promoters that provide suitable adhesion to the PK barrier layer. In exemplary embodiments, the adhesion promoters include one or more ethylene-vinyl acetate elastomer(s) (EVM) and one or more polyvinylchloride (PVC) thermoplastic(s). The exemplary composition also may contain one or more of the following additional ingredients: one or more reinforcing agent(s), one or more plasticizer(s), one or more processing aid(s), one or more antidegradant(s), one or more vulcanizing agent(s), and optionally further suitable ingredient(s) to achieve desired characteristic(s). Such ingredients of the exemplary elastomeric composition will be described in further detail below for sake of clarity and not limitation, it being understood that certain embodiments may provide different suitable combinations of these ingredient types and/or amounts, may include one or more additional ingredients or alternative equivalent ingredients in any suitable combination, or may eliminate one or more of these ingredients in any suitable combination, as would be understood by those having ordinary skill in the art in view of the teachings provided herein. These additives/ingredients may be listed under certain headings, sub-headings or paragraphs, which is done solely for organization and not limitation, it being understood that certain ingredients may have different functions or multiple functions depending on the type and/or amount incorporated into the composition, in conjunction with the other ingredient(s), as understood by those having ordinary skill in the art. Accordingly, the listing of an additive/ingredient under a heading for one class of material does not necessarily preclude its use under another class of material for a different function, unless expressly stated to the contrary.

### Base Elastomer(s)

The one or more elastomer(s) of the composition form at least part of the matrix and serve as the base of the NBR elastomeric composition. The composition also may contain other polymer(s), such as non-elastomer polymer(s), that are blended with the base elastomer(s) to also form part of the matrix of the composition. The total polymer content forming the base composition (including mixtures of base polymers) is set at 100 phr. The polymer matrix of the elastomeric composition generally will be formed from a majority of elastomer material(s) as opposed to other types of non-elastomer base polymer(s) to provide elastic properties. The additives in the composition are compounded relative to the total base polymer content of the composition, and as such may be represented in parts per hundred (phr), which means parts by weight per 100 parts by weight of the base polymer(s).

The NBR elastomeric composition includes one or more nitrile butadiene rubber(s) that constitute a major portion of the base polymer content (e.g., 50% or more by weight of the overall base polymer content). NBR is a synthetic elastomer that is derived from the polymerization of acrylonitrile monomer and butadiene monomer. The acrylonitrile content of the NBR may be in a range from about 15 wt % to about 50 wt %, more particularly about 30-50 wt. % of the polymer. NBR has a high resistance to hydrocarbon, making this material particularly suitable for the inner tube layer of a hose, for example. NBR also is flexible and can operate effectively in a wide temperature range, again making this material suitable for articles such as hose.

### Adhesion Promoter: EVM(s)

To promote adhesion of the NBR elastomeric layer to the PK barrier layer without an intervening adhesive layer, the NBR elastomeric composition includes at suitable amount of one or more ethylene-vinyl acetate polymer(s). The ethylene-vinyl acetate polymer is produced by copolymerization of ethylene and vinyl acetate. The general properties of the copolymer is determined mainly by the ratio of the two components. Polyethylene is a thermoplastic with a low glass transition temperature and high crystallinity. Polyvinylacetate is also a thermoplastic, but with a higher glass transition temperature and an amorphous structure. When vinyl acetate is copolymerized with a polyethylene chain, the resultant copolymer is usually thermoplastic; however, when the vinyl acetate content in the copolymer is increased, there are is a greater regularity of interruptions in the ethylene chain, and the more crystallization is reduced. As such, depending on the ratio of vinyl acetate to ethylene, the result of copolymerization can be an elastomeric copolymer having methylene units forming a saturated polymer backbone with pendant acetate groups. This elastomeric copolymer commonly is designated ethylene-vinyl acetate copolymer (EVM), which is a rubber-like material.

Generally, below about 40 wt. % vinyl acetate and above about 90 wt. % vinyl acetate, the thermoplastic properties of the EVM material can become predominant over the elastomeric properties. In addition, above about 60 wt. % vinyl acetate, the crystallinity of the material may become entirely absent such that the material is amorphous. As such, to impart elastic properties to the NBR elastomeric layer, the EVM polymer(s) utilized in the elastomeric composition may have a vinyl acetate content in a range from about 40% by weight of the copolymer to about 90% by weight of the copolymer. In exemplary embodiments, the EVM polymer has a vinyl acetate content from about 50% by weight of the copolymer to about 90% by weight of the copolymer. Generally, the vinyl acetate content may be in a range of about 40, 45, 50, 55, 60, 65, 70, 75, 80, 85, or 90% by weight of the copolymer.

The EVM polymer may be present in the elastomeric composition in any suitable amount and may be combined with any other suitable polymer(s) in the elastomeric composition to provide the desired overall properties for the article. For example, the total amount of EVM polymer present in the elastomeric composition may be in a range from about 5 phr to about 25 phr, more particularly from about 5 phr to about 15 phr, even more particularly from about 10 phr to about 15 phr, such as about 5, 10, 15, 20, or 25 phr (including all values and ranges between the stated values). If too little EVM polymer is in the elastomeric composition, such as less than the above-identified range(s), then the bonding performance of the NBR elastomeric layer to the PK barrier layer may be insufficient. On the other hand, if too much EVM polymer is in the elastomeric composition, such as greater than the above-identified range(s), then the elastomeric composition may have poor fuel performance, such as unsuitable swell performance when exposed to fuel, as describe in further detail below.

In exemplary embodiments, the elastomeric material is bonded to the PK material without the aid of polyketone material admixed into the elastomeric material. In other words, the elastomeric material is free of PK. Likewise, the PK material may be free of NBR and may be free of EVM. Thus, the EVM in the NBR elastomeric material serves as at least one of the adhesion promoters that facilitates a suitable chemical bond with the PK barrier layer.

### Adhesion Promoter: PVC(s)

To further promote adhesion of the NBR elastomeric layer to the PK barrier layer without an intervening adhesive layer, the NBR elastomeric composition further includes a suitable amount of one or more polyvinyl chloride (PVC) polymers. Polyvinyl chloride is a thermoplastic that is formed by the polymerization of vinyl chloride monomers.

The PVC polymer may be present in the elastomeric composition in any suitable amount to provide the desired overall properties for the article. For example, the total amount of PVC polymer present in the elastomeric composition may be in a range from about 5 phr to about 25 phr, more particularly from about 10 phr to about 20 phr, such as about 5, 10, 15, 20, or 25 phr (including all values and ranges between the stated values). If too little PVC polymer is in the elastomeric composition, such as less than the above-identified range(s), then the bonding performance of the NBR elastomeric layer to the PK barrier layer may be insufficient. On the other hand, if too much PVC polymer is in the elastomeric composition, such as greater than the above-identified range(s), then the elastomeric composition may have poor mechanical performance, such as reduced tensile strength and elongation.

The PVC polymer may be fluxed into the NBR elastomeric composition. Fluxing PVC into NBR generally may involve blending the two materials under heat and shear to create a homogeneous mixture. This fluxing process may improve aging resistance of the elastomeric composition and also may improve bonding performance of the NBR elastomeric composition to the PK barrier layer, as described in further detail below.

In exemplary embodiments, the PK material is free of PVC material and thus, the PVC in the NBR elastomeric material serves as one of the adhesion promoters that facilitates a suitable chemical bond with the PK barrier layer.

### Other Additive(s)

The elastomeric composition may include one or more reinforcing agents or reinforcing fillers in the elastomeric composition that enhance specific characteristics, such as the mechanical properties of the elastomeric composition. The reinforcing filler(s) in the elastomeric composition may be of any suitable type or combination of types and may be in any suitable amount(s) as may be desired for the application.

In certain embodiments, the elastomeric composition contains one or more different types of reinforcing agent(s) in a total amount from about 40 phr to about 120 phr, more particularly from about 60 phr to about 110 phr, such as about 40, 50, 60, 70, 80, 90, 100, 110, or 120 phr. If too much total reinforcing agent, such as greater than the above-identified range(s) is present, the elastomeric composition may become excessively stiff and less elastic, leading to a reduction in flexibility and elongation at break. If too little total reinforcing agent is added, such as below the above-identified range(s), the reinforcing effect may not be sufficient, leading to weaker mechanical properties in the rubber.

The elastomeric composition may contain one or more carbon black(s) as a reinforcing agent of the elastomeric composition. Typically, carbon blacks use a naming convention as specified by ASTM D1765 to identify the particular type and size of the carbon black. For N-series carbon blacks, grades range from N110 to N990, in which the first numerical digit designates a size or surface area of the carbon black, and the last two numerical digits designate the structural complexity of the carbon black. A lower first digit (e.g., N100-series) has a smaller particle size, and thus higher surface area, than a higher first digit (e.g., N900-series). Unlike virgin carbon black, recovered carbon black (rCB) does not use the same N-number designation system according to ASTM D1765; however, the rCB still may have at least an equivalent mean particle size as N-series designated virgin carbon black, and thus any designation of an N-type carbon black as used herein encompasses both virgin and other types of equivalent carbon black (e.g., rCB) unless specifically stated otherwise.

In exemplary embodiments, the NBR elastomeric composition contains carbon black(s) in a range between N300-series (e.g., N2 surface area from about 70 m²/g to about 99 m²/g according to ASTM D3037) and N900-series (e.g., N2 surface area from about 1 m²/g to about 10 m²/g), in which such carbon blacks(s) are present in the above-noted amounts for the additional reinforcing agent(s)—e.g., in a total amount from about from about 30 phr to about 50 phr (or subranges thereof). The proportion of N300-series carbon black may be greater than the proportion of N900-series carbon black.

Alternatively or additionally, the elastomeric composition may contain one or more silica(s) as a reinforcing agent. The silica(s) may be high surface area (precipitated) silica(s), which may have a CTAB surface area (according to ASTM D 3765) of 30 to 350 m²/g. The silica(s) may be present in the composition in a total amount from about 5 phr to about 30 phr, more particularly from about 10 phr to about 20 phr, such as about 5, 10, 15, 20, or 30 phr. When such silica(s) are used, a suitable coupling agent also may be utilized, such as a silane coupling agent (e.g., a di- tri- or tetra-sulfide silane) which may be present in a suitable amount based on the amount of silica(s).

One or more plasticizers may be present in the elastomeric composition to increase flexibility, reduce hardness, and improve the processing characteristics of the compound. The plasticizer(s) in the elastomeric composition may be of any suitable type or combination of types and may be in any suitable amount(s) as may be desired for the application. For example, the plasticizer(s) may include mineral oils, paraffinic oils, naphthenic oils, aromatic oils, vegetable oils, epoxidized oils, synthetic polymer plasticizers (e.g., liquid polybutene), ester plasticizers (e.g., esters of polycarboxylic acids such as adipic, phosphoric, phthalic, sebacic and higher aliphatic alcohols or phenols), phthalate plasticizers (e.g., Dibutyl phthalate, di-2-ethylhexyl phthalate), sebacate plasticizers (e.g., di-2-ethylhexyl sebacate), phosphate plasticizers (e.g., tricresyl phosphate), ether plasticizers (e.g., dibenzyl ether, polyethers or polyether-thioethers), monomeric plasticizer(s), or the like, or mixtures thereof.

In exemplary embodiments, the chosen plasticizer(s) is of a low-extractable or non-oil type, which may be particularly suitable for applications of the article which are exposed to chemicals such as hydrocarbon fuel. The chosen plasticizer also should be compatible with the base polymer(s) of the elastomeric composition.

The one or more plasticizers may be present in the elastomeric composition in a total amount from about 10 phr to about 40 phr, more particularly about 15 phr to about 35 phr, such as about 10, 25, 30, 35, or 40 phr. If too much total plasticizer is used in the elastomeric composition, such as greater than the above-identified range(s), then the compound may exhibit excessive softening making it difficult to process, may cause dimensional instability, and may have reduced strength. If too little plasticizer is used in the compound, such as less than the above-identified range(s), then the elastomeric composition may be hard, brittle, and/or have reduced flexibility.

The elastomeric composition may contain one or more antidegradant(s), which may include antioxidants and/or antiozonants, to prevent oxidation and/or the damaging effects of ozone, which can cause cracking and deterioration of the composition. Examples of the antidegradant(s) may include, for example, amines (e.g., naphthylamines, diphenyl amine derivatives, paraphenylenediamines such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD)), quinolines (e.g., dihydroquinolines such as 2,2,4-trimethyl-1,2-dihydroquinoline (TMQ)), thioesters (e.g., bis-(alkylthiopropionate)diesters, alkylthiodipropionate esters), dithiocarbamates (e.g., nickel or zinc salt thereof), 2-Mercaptobenzimidazole (MBI) (including its metal salt (e.g., Zinc 2-mercaptotolumidazole) (ZMTI)), hydrocarbon wax(es) (e.g., paraffin wax, microcrystalline wax), or the like, or mixtures thereof. The antidegradant(s) may be present in the elastomeric composition in a total amount of up to about 10 phr, more particularly from about 2 phr to about 8 phr, including all values between the stated values or ranges and subranges between such values.

The NBR elastomeric composition may include one or more metal oxide(s) useful as processing aids in terms of activator(s), thermal stabilizer(s), or the like as understood by those skilled in the art. Examples of metal oxides that may be present in the NBR elastomeric composition include magnesium oxide, zinc oxide, and/or calcium oxide. The metal oxide(s) may be present in the elastomeric composition in a total amount of up to about 30 phr, more particularly from about 15 phr to about 30 phr, including all values between the stated values or ranges and subranges between such values. Different types of metal oxide(s) may be present in equal or different amounts within the foregoing range. As an example, zinc oxide may be present in a range from about 5 phr to about 10 phr, and other metal oxide(s), such as MgO and CaO, in combination, may be present in an amount from about 10 phr to about 25 phr.

The NBR elastomeric composition also includes vulcanizing agent(s) or curatives that cross-link the polymer chains in the base elastomer(s), making it more elastic and less prone to deformation. The vulcanizing agent(s) may include sulfur and/or sulfur donors, or peroxides (e.g., organic peroxides such as dicumyl peroxide, bis-(t-butyl peroxy-diisopropyl benzene, t-butyl perbenzoate, di-t-butyl peroxide, 2,5-dimethyl-2,5-di-t-butylperoxyhexane, alpha-alpha-bis(t-butylperoxy) diisopropylbenzene). It is understood that some of the accelerators listed above may simultaneously be sulfur donors, but they generally are not considered direct substitutes for free sulfur in the context of a vulcanizing agent.

In certain embodiments, a cure-effective amount of the cure package (e.g., peroxide(s)) may be in a range from about 2 phr to about 20 phr, more particularly from about 5 phr to about 20 phr, including all values, ranges and subranges between the stated values. In certain embodiments, the composition is devoid of sulfur, which could be a contaminant to the substance in contact with the elastomeric layer (e.g., hydrocarbon fuel). In other embodiments, a small amount of sulfur (e.g., about 0.5 phr) may be present in the cure package in addition to the peroxide cure package.

The cure package also may include crosslinking co-agent(s) that operate together with the peroxide cure system to promote cross-linking the base polymer(s). The cross-linking co-agent(s) also may help to promote the chemical bonding effect between the elastomeric composition and the polyketone material of the barrier layer. The cross-linking co-agent(s) may be of any suitable type, such as a triallyl cyanurate (TAC) or diallyl cyanurate, or PDM (N,N′-m-phenylene bismaleimide), for example.

### Material Properties

The elastomeric composition may have properties that make it particularly suitable for permeation resistant applications, such as for hoses, or the like. Accordingly, in exemplary embodiments, the material properties of the cured elastomeric composition may include one or more original properties of: (i) elongation at break of greater than about 70%, more particularly greater than 100%, such as in a range from about 70% to about 350%; (ii) modulus at 100% of greater than 500 psi, such as from about 500 psi to about 1,500 psi; (iii) tensile strength of greater than 1,000 psi, more particularly greater than about 1,250 psi, such as from about 1,000 psi to about 4,000 psi; (iv) Shore A hardness in a range from about 70 to 90.

The elastomeric composition also may have cure time at temperature that permits flowability of the elastomeric composition to promote contact and bonding to the PK barrier layer. For example, at a temperature of about greater than 150 °F the material may begin to flow, and the cure time to reach a cure temperature (e.g., about 305 °F) may be greater than 30 minutes, such as in a range from 30 minutes to 90 minutes to promote bonding to the PK barrier layer.

In exemplary embodiments, the bonding performance of the NBR elastomeric layer to the PK barrier layer may be characterized by an average load per width of 10 lbf/in or greater, more particularly 15 lbf/in or greater, even more particularly 25 lb/in or greater, such as in a range from 10 lbf/in to 50 lbf/in, such values being according to ASTM D413-98. Ideally, the failure mode of the peel/bond test is predominantly through the NBR elastomeric composition (stock tear) instead of at the interface between the elastomeric layer and the PK layer. Such stock tear through the cured elastomeric material may demand about 10 lbf/in or greater, or 15 lbf/in or greater, for example.

To provide suitability as an inner tube layer of a hose or other part of the article exposed to hydrocarbon fuel, the NBR elastomeric layer may have one or more of: (i) retained tensile when immersed in Fuel H for 70 hours at room temperature according to ASTM D471 of about 40% or more; more particularly about 45% or more; (ii) retained elongation when immersed in Fuel H for 70 hours at room temperature according to ASTM D471 of about 50% or more; and/or (iii) a volume swell percentage when immersed in Fuel H for 70 hours at room temperature according to ASTM D471 of about 50% or less; more particularly about 40% or less; even more particularly about 35% or less.

### EXAMPLES

Example elastomeric compositions were prepared and tested for the purpose of further illustrating the nature of some of the embodiments and aspects of the disclosure and are not intended as a limitation on the scope thereof. These examples are shown in Tables 2 through 8, in which the Examples (Ex. 1-12) include NBR base rubber, EVM adhesion promoter and PVC adhesion promoter, and Comparative Examples (Comp. 1) do not contain EVM and do not contain PVC adhesion promoters. In the test data, results for tensile, elongation, and modulus were determined by ASTM-D412 at ~25 °C. The results for fuel immersion aging, including retained tensile, elongation and volume swell were determined according to ASTM D471. The PK adhesion evaluations were determined by a peel test method according to ASTM D413-98 at ~25 °C. In particular, the elastomeric composition of the examples were bonded to a polyketone layer, namely a polyketone sold by Hyosung under the trade name POKETONE M710F, in which the composite test sample including the elastomeric composition bonded to the PK barrier material was cured under pressure of 80 psi to simulate hose curing conditions.

TABLE 2

| Ingredient | Units | Ex. 1 | Ex. 2 | Ex. 3 | Ex. 4 |
|---|---|---|---|---|---|
| Base Elastomer(s): 41% | phr | 56 | 80 | 80 | 80 |
| ACN NBR | | | | | |
| Adhesion Promoter: | phr | 20 | 20 | 20 | 20 |
| 60% Vinyl Acetate EVM | | | | | |
| Adhesion Promoter: 55 | phr | 24 | 15 | 30 | 15 |
| K value PVC | | | | | |
| Reinforcing Agent: | phr | 95 | 95 | 95 | 95 |
| Carbon Black(s) | | | | | |
| Reinforcing Agent: | phr | 15 | 15 | 15 | 15 |
| Silica(s) | | | | | |
| Plasticizer(s) | phr | 28 | 28 | 28 | 28 |
| Antidegradant(s) | phr | 4 | 4 | 4 | 4 |
| Silane Coupling Agent | phr | 2 | 2 | 2 | 2 |
| TBPB + SiO2 (Zeonet | phi | 4.2 | 4.2 | 4.2 | 4.2 |
| PB - Tokyo Zairyo) | | | | | |
| Metal Oxide(s): ZnO | phr | 5 | 5 | 5 | 5 |
| Metal Oxide(s): MgO + | phr | 20 | 20 | 20 | 20 |
| CaO | | | | | |
| Peroxide Cure System | phr | 16.1 | 16.1 | 16.1 | 16.1 |
| Sulfur | phr | 0 | 0 | 0 | 0.5 |
| Total PHR: | phr | 289.3 | 304.3 | 319.3 | 304.8 |
| Fluxed PVC in NBR: | — | Yes | Yes | Yes | Yes |

TABLE 3

| Ingredient | Units | Ex. 5 | Ex. 6 | Ex. 7 |
|---|---|---|---|---|
| Base Elastomer(s): 41% ACN NBR | phr | 95 | 95 | 90 |
| Adhesion Promoter: 60% Vinyl | phr | 5 | 5 | 10 |
| Acetate EVM | | | | |
| Adhesion Promoter: 55 K value PVC | phr | 5 | 5 | 10 |
| Reinforcing Agent: Carbon Black(s) | phr | 95 | 95 | 95 |
| Reinforcing Agent: Silica(s) | phr | 15 | 15 | 15 |
| Plasticizer(s) | phr | 28 | 28 | 28 |
| Antidegradant(s) | phr | 4 | 4 | 4 |
| Silane Coupling Agent | phr | 2 | 2 | 2 |
| TBPB + SiO2 (Zeonet PB - | phr | 4.2 | 4.2 | 4.2 |
| Tokyo Zairyo) | | | | |
| Metal Oxide(s): ZnO | phr | 5 | 5 | 5 |
| Metal Oxide(s): MgO + CaO | phr | 20 | 20 | 20 |
| Peroxide Cure System | phr | 16.1 | 16.1 | 16.1 |
| Sulfur | phr | 0.5 | 0.5 | 0.5 |
| Total PHR: | phr | 294.8 | 294.8 | 299.8 |
| Fluxed PVC in NBR: | — | No | Yes | No |

TABLE 4

| | | Ex. | Ex. | Ex. | Ex. | Ex. |
|---|---|---|---|---|---|---|
| Ingredient | Units | 8 | 9 | 10 | 11 | 12 |
| Base Elastomer(s): 41% | phr | 85 | 90 | 95 | 90 | 90 |
| ACN NBR | | | | | | |
| Adhesion Promoter: 60% | phr | 15 | 10 | 5 | 10 | 10 |
| Vinyl Acetate EVM | | | | | | |
| Adhesion Promoter: 55K | phr | 15 | 15 | 15 | 20 | 10 |
| value PVC | | | | | | |
| Reinforcing Agent: Carbon | phr | 95 | 95 | 95 | 95 | 95 |
| Black(s) | | | | | | |
| Reinforcing Agent: Silica(s) | phr | 15 | 15 | 15 | 15 | 15 |
| Plasticizer(s) | phr | 28 | 28 | 28 | 28 | 28 |
| Antidegradant(s) | phr | 4 | 4 | 4 | 4 | 4 |
| Silane Coupling Agent | phr | 2 | 2 | 2 | 2 | 2 |
| TBPB + SiO2 (Zeonet PB - | phr | 4.2 | 4.2 | 4.2 | 4.2 | 4.2 |
| Tokyo Zairyo) | | | | | | |
| Metal Oxide(s): ZnO | phr | 5 | 5 | 5 | 5 | 5 |
| Metal Oxide(s): MgO + CaO | phr | 20 | 20 | 20 | 20 | 20 |
| Peroxide Cure System | phr | 16.1 | 16.1 | 16.1 | 16.1 | 16.1 |
| Sulfur | phr | 0.5 | 0.5 | 0.5 | 0.5 | 0.5 |
| Total PHR: | phr | 304.8 | 304.8 | 304.8 | 309.8 | 299.8 |
| Fluxed PVC in NBR: | — | Yes | Yes | Yes | Yes | Yes |

TABLE 5

| Test Method | Units | Comp. 1 | Ex. 1 | Ex. 2 | Ex. 3 | Ex. 4 |
|---|---|---|---|---|---|---|
| Original Tensile | psi | 2020 | 1854 | 1778 | 1641 | 1706 |
| Original Elongation | psi | 253 | 67 | 102 | 78 | 106 |
| Air aging 70/212% | % | 101% | 92% | 96% | 125% | 109% |
| Tensile retained | | | | | | |
| Air aging 70/212% | % | 76% | 63% | 72% | 96% | 86% |
| Elongation retained | | | | | | |
| Fuel H 70/RT % Tensile | % | 48% | 36% | 30% | 40% | 22% |
| retained | | | | | | |
| Fuel H 70/RT % | % | 57% | 67% | 39% | 62% | 26% |
| Elongation retained | | | | | | |
| Fuel H 70/RT Volume | % | 32% | 48% | 51% | 52% | 51% |
| Swell | | | | | | |
| Polyketone Adhesion | lbf/in | — | Stock | Stock | Stock | Stock |
| | | | Tear | Tear | Tear | Tear |
| Wire Adhesion | lbf | — | 4.77 | 3.65 | 2.97 | 4.73 |

TABLE 6

| Test Method | Units | Ex. 5 | Ex. 6 | Ex. 7 |
|---|---|---|---|---|
| Original Tensile | psi | 1566 | 1633 | 1712 |
| Original Elongation | psi | 184 | 174 | 134 |
| Air aging 70/212% Tensile retained | % | 88% | 93% | 100% |
| Air aging 70/212% Elongation | % | 66% | 76% | 66% |
| retained | | | | |
| Fuel H 70/RT % Tensile retained | % | 49% | 46% | 44% |
| Fuel H 70/RT % Elongation retained | % | 57% | 58% | 49% |
| Fuel H 70/RT Volume Swell | % | 33% | 32% | 33% |
| Polyketone Adhesion | lbf/in | 3.0 | 5.3 | 7.2 |
| Wire Adhesion | lbf | 3.3 | 3.1 | 3.5 |

TABLE 7

| Test Method | Units | Ex. 8 | Ex. 9 | Ex. 10 | Ex. 11 | Ex. 12 |
|---|---|---|---|---|---|---|
| Original Tensile | psi | 1709 | 1817 | 1782 | 1903 | 1455 |
| Original Elongation | psi | 110 | 127 | 142 | 129 | 148 |
| Air aging 70/212% | % | 104% | 101% | 98% | 97% | 105% |
| Tensile retained | | | | | | |
| Air aging 70/212% | % | 98% | 86% | 72% | 75% | 78% |
| Elongation retained | | | | | | |
| Fuel H 70/RT % | % | 45% | 35% | 47% | 39% | 50% |
| Tensile retained | | | | | | |
| Fuel H 70/RT % | % | 57% | 46% | 51% | 53% | 45% |
| Elongation retained | | | | | | |
| Fuel H 70/RT Volume | % | 49% | 45% | 40% | 45% | 45% |
| Swell | | | | | | |
| Polyketone Adhesion | lbf/in | 5.1 | 9.9 | 5.2 | 9.6 | 3.6 |
| Wire Adhesion | lbf | 5.7 | 4.9 | 5.3 | 5.7 | 4.5 |

It was observed in the testing of Examples 8-12 that the PK adhesion was lower than expected. This led to a theory that the PK sheet material used in examples of Table 7 had surface issues which resulted in poor bonding performance. Accordingly, another study was performed to test the bonding performance under a control, in which there was no surface preparation similarly to the above results, as compared against sanding the bonding surface of the PK barrier material to remove any surface defects that may be present. The results of this additional study are shown in Table 8.

TABLE 8

| Polyketone Adhesion | | | |
|---|---|---|---|
| Test: | Ex. 4 | Ex. 8 | Ex. 12 |
| No Surface Prep | 2.8 lbf/in | 5.5 lbf/in | 4.3 lbf/in |
| (Control) | (No stock | (Partial stock | (No stock |
| | tear) | ear) | tear) |
| Sanded Bonding | 14.3 lbf/in | 14.3 lbf/in | 10.2 lb/in |
| Surface | (Stock Tear) | Stock Tear) | (½ Stock Tear) |

As can be seen in this study of Table 8, Example 4, which originally exhibited stock tear in Table 5, did not exhibit stock tear when using the same sheet of PK material used in the Table 7 results, confirming a problem with the surface of the PK sheet material used in the Table 7 tests. On the other hand, the sanding appeared to remove such defect of the PK surface and again resulted in stock tear for Example 4. The bonding performance of Examples 8 and 12 also improved with the sanding surface preparation. It therefore stands to reason that the other PK adhesion values for Examples 8-12 in Table 7 would be improved similarly to the improvement shown in the study of Table 8.

The results of this testing unexpectedly demonstrated that the incorporation of certain amounts of both EVM polymer and PVC polymer in the NBR elastomeric material improved bonding performance to the PK barrier layer material.

For example, referring to Examples 2-4, the data suggests that relatively high levels of both EVM and PVC (15+ phr for both) produced very good adhesion to polyketone. However, it also was found that such relatively high levels negatively affected volumetric swell of the material when immersed in fuel. While some fuel swell is expected, as demonstrated by the control of the Comparative Example (a nitrile rubber without EVM or PVC), an acceptable level of fuel swell may be about 50% or less, more particularly about 45% or less, or even more particularly about 40% or less. On the other hand, Examples 5 and 6, which used relatively low levels of both EVM and PVC (5 phr for both), improved fuel swell but did not have adequate bonding performance to the PK barrier layer material because it was less than e.g., about 10 lbf/in and/or did not have stock tear.

Examples 8-12 demonstrate levels of EVM and PVC that could attain a suitable balance of PK adhesion performance and fuel swell performance (again noting that the adhesion values in Table 7 should account for the study of Table 8 and thus are understood to be increased compared to what is shown in Table 7, likely resulting in stock tear for Examples 8-11). Based on such data, it was unexpectedly found that a total amount of EVM polymer(s) in a range from about 5 phr to about 15 phr, more particularly about 10 phr to about 15 phr, along with a total amount of PVC polymer(s) in a range from about 10 phr to about 20 phr, more particularly about 10 phr to about 15 phr, will facilitate adhesion to a PK barrier layer (e.g., with a bond strength of about 10 lbf/in or greater, more particularly 15 lbf/in or greater, preferably with stock tear) while having a relatively low volumetric fuel swell when immersed in Fuel H 70/RT (e.g., less than about 50% swell, more particularly about 45% or less fuel swell, even more particularly about 40% or less fuel swell). As demonstrated in the data, when the total EVM content is greater than about 15 phr, the fuel swell performance may become unacceptable; and it is understood that below about 5 phr total EVM(s) the bonding performance may be unacceptable. In certain embodiments, the total EVM content is from 10 phr to 15 phr to attain suitable performance. In addition, the data suggests that when the total PVC content is less than 10 phr, the bonding performance may be unacceptable; and it is understood that greater than 20 phr PVC may embrittle the compound, resulting in poorer mechanical properties, and also may have issues with immiscibility.

Also as shown in the test data, fluxing of the PVC(s) into the NBR elastomeric composition may improve adhesion to the PK barrier layer, as demonstrated in at least a comparison between Examples 5 and 6.

The results also show that such NBR elastomeric composition may have suitable wire adhesion, which may make this material suitable as an intermediate layer of an article that adheres to metal wire reinforcement.

### Article Embodiment(s)

Certain embodiments of the disclosure will hereafter be described with reference to the accompanying drawings, in which like reference numerals denote like elements. It should be understood, however, that the accompanying figures illustrate the various implementations described herein and are not meant to limit the scope of various technologies described herein. In addition, it is understood that various aspects and features of these embodiments may be substituted for one another or used in conjunction with one another where applicable. Furthermore, it is understood that the description of material(s) forming the various parts of one embodiment article may be the same material(s) for the same or similar part in another embodiment article, except as otherwise noted below.

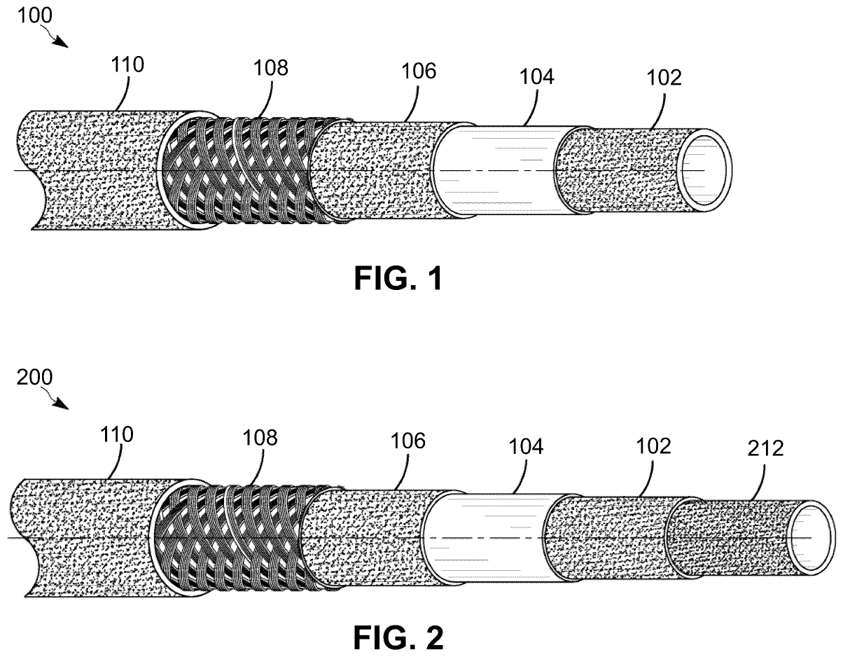

Referring to FIG. 1, a barrier-type reinforced hose 100 is shown in a cut-away perspective view. The hose 100 includes an elastomeric layer 102 forming an inner tube (also 102) that forms an internal fluid passage, or lumen, through which fluid is conveyed. A permeation inhibiting barrier layer 104 is disposed outwardly of the inner tube 102. Disposed outwardly and adjacent to the permeation inhibiting barrier layer 104 is an intermediate layer 106. A reinforcing layer 108 is disposed outwardly from the intermediate layer 106. A cover layer 110 is disposed outwardly from the reinforcing layer 108 and is the outermost layer of the illustrated hose 100.

The inner tube 102 of the hose 100 is formed from an elastomeric composition which provides flexibility and elasticity. The elastomeric composition forming the inner tube 102 of the hose also may provide low extractables and chemical resistance to the substance being conveyed by the hose. In exemplary embodiments, the inner tube 102 is formed from the exemplary NBR elastomeric composition described above. In alternative embodiments, the inner tube 102 is formed from a different elastomeric composition.

The inner tube 102 may have any suitable wall thickness to provide the properties desired for the application. In certain embodiments, hose 100 may have an inside diameter which is within the range of about 0.5 inch (12.7 mm) to about 6 inches (about 150 mm). The wall thickness of the inner tube 102 may be in a range from about 0.02 inch (0.5 mm) to about 0.16 inch (4 mm), more particularly from about 1 mm to about 3 mm.

The barrier layer 104 is configured to reduce permeation of the substance being conveyed, such as vapors from the liquid hydrocarbon fuel, to reduce losses. The barrier layer 104 is formed from the polyketone (PK) barrier layer described above. As noted above, when the inner tube 102 is formed from the exemplary elastomeric composition described above, the barrier layer 104 may be disposed adjacently and directly bonded to the inner tube 102 without an intervening adhesive layer. Alternatively, in some embodiments, the inner tube 102 may be formed from a different material and/or an adhesive layer may be employed.

To provide adequate permeation resistance while also maintaining suitable flexibility of the hose 100, the barrier layer 104 may have a wall thickness in a range from about 0.001 inch (0.025 mm) to about 0.030 in (0.76 mm), more particularly from about 0.002 inch (0.05 mm) to about 0.01 inch (0.254 mm) thick, for example.

The intermediate layer 106 may be formed as a backing layer, a tie layer, and/or a friction layer. As a backing layer, the layer 106 may provide additional stability to the hose. As a tie layer, the layer 106 is disposed adjacently and directly bonded to the opposite side of the PK barrier layer 104 without an intervening adhesive layer. The tie layer 106 may be formed from the same or similar NBR elastomeric composition as described above to provide such a direct bond. Alternatively, the tie layer 106 may be formed from a different material and/or an adhesive layer may be employed. In addition, to “tie” the PK barrier layer 104 to the reinforcement layer 108, the tie layer 106 may provide bonding to the reinforcement layer 108, either directly or with the use of adhesive coating. As a friction layer, the layer 106 generally serves to reduce wear by restricting rubbing of the reinforcement against the adjacent layer and may or may not be bonded to the reinforcement layer 108.

The layer 106 may have any suitable wall thickness for the application, and in some embodiments may be in a range from about 0.010 inches (0.25 mm) to about 0.120 inches (3 mm), for example.

The reinforcement layer 108 provides additional strength to the hose, typically by incorporating filaments of reinforcement into the hose, such as around the tube layer 102 or an intermediate layer. The reinforcement filaments may have any suitable configuration or combination of configurations, and the reinforcement filaments may be made of any suitable material or combination of materials for reinforcing the hose. The reinforcement layer 104 may include one or more layers of such filaments, which these reinforcement sub layers may be directly radially adjacent to each other and/or may be separated by intervening layer(s) of material (e.g., rubber layer between reinforcement sub layers).

The reinforcement filaments may include elongated fibers, threads, wires, bands, or the like, or mixtures thereof, which may be in monofilament or multi-filament form. The individual filaments may be grouped together to form bundles, strands, tows, yarns, cords, or the like. Generally, a tow or strand may be a bundle of untwisted individual filaments, a yarn may be a bundle of twisted or cabled individual filaments, and a cord may be bundle of twisted, braided, or cabled yarns/strands or bundle of yarns/strands plied together into a thicker, stronger form. The individual filaments or grouping of filaments (e.g., strands, yarns, cords) may be arranged in a spiral, braided, knitted, fabric, or wrapped reinforcement construction. In some embodiments, the hose may include one or more of these layers of reinforcement, and each layer may have a different orientation of its filament arrangement. For example, where two or more layers of spiral reinforcement may be used, a first layer may have strands/yarns/cords spiral wound in a first winding direction, and a second layer may have strands/yarns/cords spiral wound in a second winding direction opposite the first winding direction. A braided configuration may include groupings of filaments (e.g., strands, yarns, cords) arranged in a 1-over, 1-under braid pattern, a 3-over, 3-under braid pattern, or a 4-over, 4-under braid pattern, or the like.

The reinforcement material of the filaments may include, but is not limited to, metal, synthetic or natural material, or mixtures thereof. For example, the reinforcement filaments may be metal wire (such as steel wire, stainless-steel wire, plated-steel wire, plain steel wire, or the like). Synthetic materials may include nylon, vinylon, aramid, rayon, polyester (such as polyethylene terephthalate or polyethylene naphthalate), polyvinyl acetate, polyvinyl alcohol (PVA), poly p-phenylene-2,6-benzobisoxazole (PBO), polypropylene, polyamide, carbon fiber, or the like. Natural, ceramic, mineral, etc. fibers may include cotton, jute, hemp, basalt, glass, or the like.

For the performance characteristics of a fuel transfer hose, such as a curb pump hose, the reinforcement layer 108 may have an arrangement of metal wires that are in a spiral wound or braided configuration. For example, the reinforcement layer 108 may be formed by braided steel wires manufactured utilizing a braiding machine having 16 to 36 carriers (bobbins of wire), with 2 to 12 wire ends of about 0.006 to about 0.015 inch (0.15 mm to 0.38 mm) gage. The braided steel wire used in the reinforcement layer 108 may have a wire pack coverage, which is within the range of about 30 percent to about 65 percent, in which the remaining 35 percent to 70 percent of the friction layer 104 is exposed through windows in the braid pattern. In other embodiments, to attain improved kink resistance, the reinforcement layer 108 may include multiple spiral laid wires of different sizes in conjunction with a textile braided construction.

The cover layer 110 is located outwardly of the reinforcement layer 108 and serves to protect the inner layers from the environment of the hose when deployed for use in the field. The cover layer 110 may have any suitable configuration and be made of any suitable material. Several factors may be used to determine the construction and/or materials selection for the cover layer, including but not limited to abrasion resistance, chemical resistance, economy, formability, aesthetics, or the like.

The cover layer 110 material may include, but is not limited to, natural rubber (NR), epoxidized natural rubber (ENR), polybutadiene rubber (BR), acrylonitrile butadiene rubber (NBR), carboxylated nitrile rubber (XNBR), (partially) hydrogenated nitrile rubber (HNBR), styrene butadiene rubber (SBR), carboxylated styrene-butadiene rubber (XSBR), styrene/ethylene-butylene/styrene-based (SEBS), ethylene propylene monomer (EPM), ethylene propylene diene monomer (EPDM), chloroprene rubber (CR), isoprene rubber (IR), butyl rubber (IIR), bromobutyl rubber (BIIR), chlorobutyl rubber (CIIR), chlorinated polyethylene (CPE), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorine rubber (FKM), fluorinated methylsilicone rubber (MFQ), perfluorinated propylene rubber (FFPM), perfluorocarbon rubber (FFKM), thermoplastic elastomers (TPE), thermoplastic vulcanizates (TPV), thermoplastic polyurethanes (TPU), polyolefin elastomers (POE), polyvinylchloride (PVC), and/or polyurethane (PU), and/or the like, or blends thereof. In exemplary embodiments, the cover layer 110 includes PVC/NBR or PVC/XNBR mixtures.

The cover layer compound may further include various additives of suitable types and amounts, such as those described above for elastomeric layer, which may include, but is not limited to, pigments and/or dyes to provide a color, retardants, antioxidants, vulcanizing agents, cure accelerators or other processing aids, reinforcing agents and fillers, such as carbon black, silica, other mineral fillers (e.g., calcium carbonate, talc, etc.), or the like. As an example, reinforcing fillers may be provided in a broad range from about 20 phr to about 700 phr, including for example carbon black from about 200 phr to about 400 phr; and plasticizers such as oils may be provided in a range from about 10 phr to about 200 phr.

The cover layer 110 may have any suitable wall thickness, such as from about 0.060 inches (1.5 mm) to about 0.120 inches (3.0 mm), from about 0.070 inches (1.5 mm) to about 0.110 inches (2.8 mm) in thickness, or from about 0.080 inches (1.8 mm) to about 0.100 inches (2.5 mm) in thickness.

An exemplary method of forming the hose 100, may include at least the following steps: extruding the elastomeric layer 102; extruding the PK barrier layer 104; wherein the elastomeric layer 102 and the PA barrier layer 104 are in direct contact without an intervening adhesive layer; activating the cure system by increasing temperature; crosslinking the elastomeric layer 102 and directly bonding the elastomeric layer 102 to the PK barrier layer.

More specifically, a manufacturing process may include: mixing together the ingredients of the elastomeric composition; extruding the elastomeric composition to form the inner tube layer 102; extruding the PK barrier layer 104 directly onto the inner tube layer 102 without an intervening adhesive layer; extruding the tie layer 106 directly onto the PK barrier layer 104 without an intervening adhesive layer; applying the reinforcement layer 108; extruding the cover layer to overly the reinforcement layer 108; activating the peroxide cure system in at least the inner tube layer 102 and the tie layer 106 by increasing temperature; crosslinking the elastomeric composition of the inner tube layer 102 and tie layer 106; and directly bonding the inner tube layer 102 and tie layer 106 to the PK barrier layer 104.

Turning to FIG. 2, another embodiment of a hose 200 is shown in which a different material layer 212 forms the inner tube, and the elastomeric layer 102 formed from the elastomeric composition described above is disposed outwardly of the inner tube layer 212. In this embodiment, the material of inner tube layer 212 may be optimized for chemical resistance to the substance conveyed. For example, in a fuel transfer hose, the material of inner tube layer 212 may include NBR, HNBR, or the like. An adhesion layer may be disposed between the inner tube layer 212 and the elastomeric layer 102, or the inner tube layer 212 may be directly bonded to the layer 102.

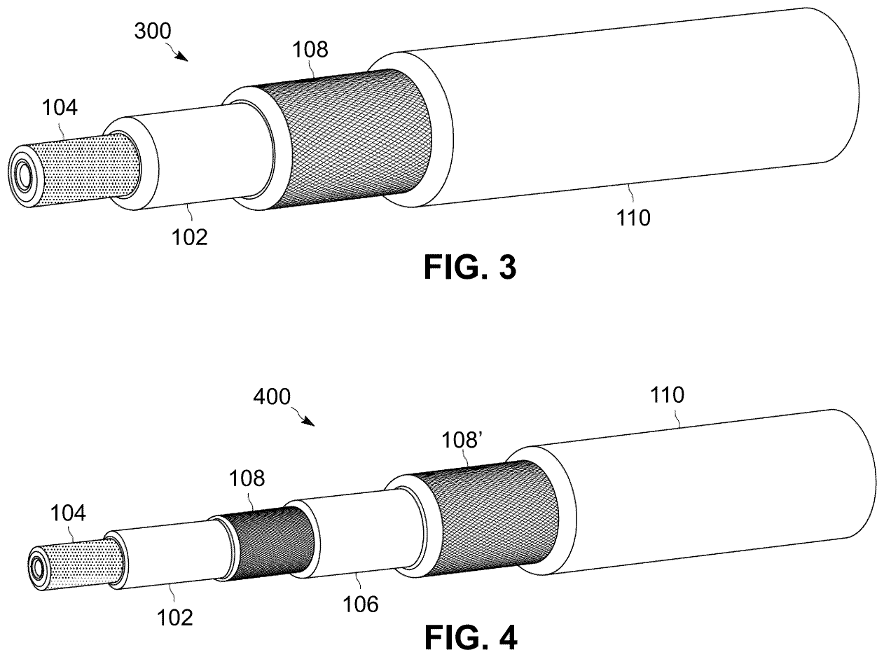

FIG. 3 shows another embodiment of hose 300 in which the PK barrier layer 104 forms the inner tube and the elastomeric layer 102 formed from the elastomeric composition described above is disposed outwardly of the barrier layer 104. Such a hose may be particularly useful in applications such as refrigerant hose or fuel hose. In this embodiment, there may be no intermediate layer 106, and the reinforcement layer 108 may be disposed outwardly adjacent to the elastomeric layer 102. The cover layer 110 is the outermost layer.

FIG. 4 shows yet another embodiment of hose 400, which is similar to hose 300 in which the PK barrier layer 104 forms the inner tube and the elastomeric layer 102 formed from the elastomeric composition described above is disposed outwardly of the barrier layer 104. The hose 400 differs in that it includes two reinforcement layers 108, 108′, which may be the same or different, and an intermediate layer 106, such as a friction layer or tie layer, is disposed between the reinforcement layers 108, 108′. The cover layer 110 is the outermost layer.

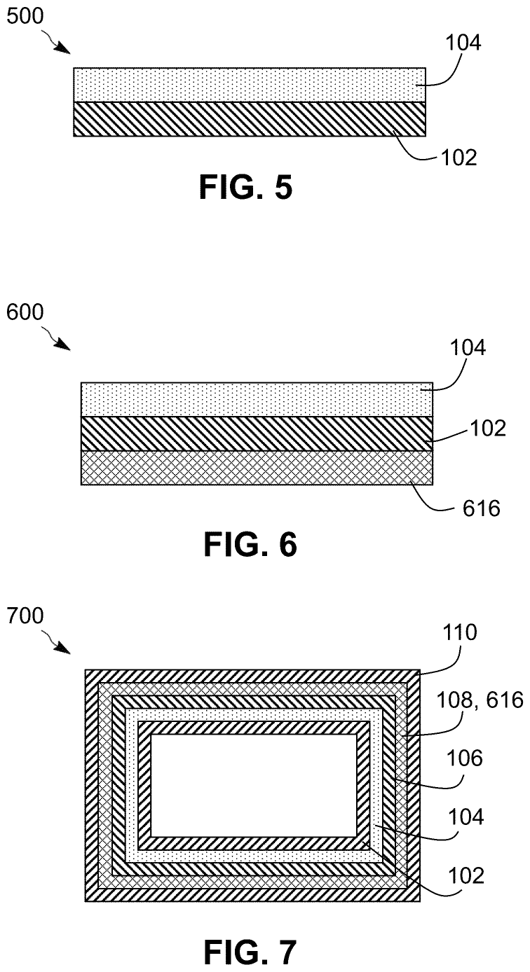

FIG. 5 shows a cross-sectional view of an article 500 having an elastomeric layer 102 formed from the elastomeric composition described above, which is directly bonded to a PK barrier layer 104 without an adhesive intervening layer, in the manner described above. The article 500 is a permeation resistant article, which may be formed as a membrane, a seal, or the like.

FIG. 6 shows a cross-sectional view of another article 600 that is similar to article 500, except that article 600 further includes a reinforcement layer 616. The reinforcement layer may be the same as or similar to reinforcement layer 108 described above. Alternatively, the reinforcement layer 108 may include a different configuration of reinforcement filaments than are used with a hose. The reinforcement filaments in the layer 616 may include bi-directional, non-woven, woven, knitted, or braided fabric. The fabric may include warp and weft threads laid at any desired angle. The fabric layer 120 may be a plated knitted fabric including courses of yarn knitted together. In some embodiments, more than one ply of fabric may be employed. If desired, the fabric may be cut on a bias so that the filaments form an angle with the longitudinal direction of the. The angle may be of any suitable angle, for example, but not limited to 0 or 90 degrees, or any point along the continuum there between. The fabrics for use in reinforcement layer 616 may be formed from any suitable material or combination of materials. For example, the fabrics for use in the reinforcement layer 616 may be formed from materials including nylon (such as nylon 4,6, nylon 6, 6, and nylon 6), cotton, polyester, cotton/polyester, nylon/polyester, cotton/nylon, aramid, rayon, or the like. Hybrid designs, for reinforcement layer 616 may be coated with an elastomeric material. In some embodiments, the fabric layer may have a different coating on one side to assure that the fabric layer 616 is bonded to the elastomeric layer 102 (for example); and may have a different coating on the opposite side to provide low friction, abrasion resistance, or other suitable function.

FIG. 7 shows a cross-sectional view of another article 700, which is a permeation resistant article that encloses a space to contain a substance. Such an article 700 may be a bladder, container, or the like. The article 700 includes a similar layer configuration as the hose 100, and as such the same reference numerals are used to denote like elements. The reinforcement layer 108 may be configured as a reinforcement layer for a hose, as described above, or may have a reinforcement structure more similar to the layer 616 described above.

It is understood that the articles 500, 600 and 700 are not limited to the layers shown, but also could include additional layers on either side or as intermediate layers, as may be desired for the particular application.

According to an aspect, an NBR elastomeric composition capable of bonding directly to a PK barrier layer without an intervening adhesive layer, includes: one or more nitrile butadiene elastomer(s) (NBR) in a total amount from 50 phr to 100 phr, more particularly from 80 phr to 100 phr; one or more ethylene-vinyl acetate elastomer(s) (EVM) in a total amount from 5 phr to 20 phr; more particularly from 5 phr to 15 phr; more particularly from 10 phr to 15 phr; and one or more polyvinylchloride polymer(s) (PVC) in a total amount from 10 phr to 20 phr; more particularly from about 10 phr to 15 phr.

According to an aspect, a multilayer article configured for permeation resistance includes: an NBR elastomeric layer directly bonded to a polyketone (PK) barrier layer without an intervening adhesive layer, the NBR elastomeric layer formed from a composition according to the foregoing, in particular comprising: one or more nitrile butadiene elastomer(s) (NBR) in a total amount from 50 phr to 100 phr, more particularly from 80 phr to 100 phr; one or more ethylene-vinyl acetate elastomer(s) (EVM) in a total amount from 5 phr to 15 phr; and one or more polyvinylchloride polymer(s) (PVC) in a total amount from 10 phr to 20 phr.

According to an aspect, a multilayer hose includes: an NBR elastomeric layer directly bonded to a polyketone (PK) barrier layer without an intervening adhesive layer, the NBR elastomeric layer formed from a composition according to the foregoing, in particular comprising: one or more nitrile butadiene elastomer(s) (NBR) in a total amount from 50 phr to 100 phr, more particularly from 80 phr to 100 phr; one or more ethylene-vinyl acetate elastomer(s) (EVM) in a total amount from 5 phr to 15 phr; and one or more polyvinylchloride polymer(s) (PVC) in a total amount from 10 phr to 20 phr.

According to an aspect, a method of manufacturing a hose includes: mixing the ingredients of an elastomeric composition; extruding the NBR elastomeric composition as a layer of the hose; extruding a PK barrier layer; wherein the elastomeric layer and the PK barrier layer are in direct contact without an intervening adhesive layer; crosslinking the NBR elastomeric layer and directly bonding the elastomeric layer to the PK barrier layer.

According to an aspect, a fuel system includes: a source of hydrocarbon fuel, in particular liquid hydrocarbon gasoline; the hose according to any of the foregoing or following fluidly connecting the source of fuel.

Exemplary embodiment(s) may include one or more of the following additional features combined with any of the foregoing aspects, in which one or more of these additional features may be combined separately or in any suitable combination with each other.

In exemplary embodiment(s), the elastomeric layer exhibits bonding strength to the polyketone barrier layer of 10 lbf/in or greater, more particularly 15 lbf/in or greater, such as up to 50 lbf/in or stock tear, when tested according to ASTM D413-98.

In exemplary embodiment(s), the elastomeric layer has one or more of: (i) retained tensile when immersed in Fuel H for 70 hours at room temperature according to ASTM D471 of 40% or more; more particularly 45% or more; (ii) retained elongation when immersed in Fuel H for 70 hours at room temperature according to ASTM D471 of 50% or more; and/or (iii) a volume swell percentage when immersed in Fuel H for 70 hours at room temperature according to ASTM D471 of 50% or less; more particularly 45% or less; more particularly 40% or less.

In exemplary embodiment(s), the elastomeric layer exhibits bonding strength to the polyketone barrier layer of 15 lbf/in or greater, or stock tear of the elastomeric layer; and the elastomeric layer has a volume swell percentage when immersed in Fuel H for 70 hours at room temperature according to ASTM D471 of about 45% or less.

In exemplary embodiment(s), the one or more PVC(s) are fluxed with the one or more NBR(s).

In exemplary embodiment(s), the one or more EVM(s) are present in a total amount from 10 phr to 15 phr.

In exemplary embodiment(s), the one or more PVC(s) are present in a total amount from 10 phr to 15 phr.

In exemplary embodiment(s), the one or more EVM(s) and the one or more PVC(s) serving as adhesion promoters are present in a total amount that improves bonding to the PK barrier layer as compared to a same elastomeric composition without any EVM(s) and PVC(s).

In exemplary embodiment(s), the polyketone barrier layer exhibits a permeation rate of CE10 fuel of less than 15 g/m²/day, more particularly less than 10 g/m²/day, more particularly less than 5 g/m²/day, or even more particularly less than 1 g/m²/day when tested according to SAE J2665 at 25 °C and 30 in·Hg.

In exemplary embodiment(s), the polyketone barrier layer is formed from an essentially pure aliphatic polyketone material of formula [[—CHR₁CH₂(C═O)—]ₙ[—CHR₂CH₂(C═O)—]ₘ]_{P} where R₁ and R₂ are different from each other and are independently hydrogen or a C₁-C₁₂-alkyl group, n+m=1, and p is an integer, and the two comonomers may be randomly distributed or present as blocks.

In exemplary embodiment(s), the one or more EVM(s) have a vinyl acetate content in a range from 40% by weight of the copolymer to 90% by weight of the copolymer, more particularly from 50 wt. % to 90 wt. %.

In exemplary embodiment(s), the elastomeric composition further comprises one or more reinforcing agent(s), more particularly carbon black(s) and/or silica(s), in a total amount from 40 phr to 125 phr, more particularly from 60 phr to 110 phr.

In exemplary embodiment(s), the elastomeric composition has a cure effective amount of a curative system, more particularly wherein the curative system includes a peroxide cure system.

In exemplary embodiment(s), the material properties of the elastomeric composition includes one or more original properties of: (i) elongation at break of greater than 70%, more particularly greater than 100%; (ii) modulus of elasticity at 100% of greater than 500 psi; (iii) tensile strength of greater than 1,000 psi; and/or (iv) Shore A hardness in a range from 70 to 90.

In exemplary embodiment(s), the NBR elastomeric layer forms an inner layer of the hose; the PK barrier layer is disposed outwardly of the elastomeric layer; a tie layer is disposed outwardly of the PK barrier layer, a reinforcement layer disposed outwardly of the tie layer; and a cover layer disposed outwardly of the reinforcement layer.

In exemplary embodiment(s), the tie layer being directly bonded to the PK barrier layer without an intervening adhesive layer, and wherein the tie layer is formed from a second NBR elastomeric composition which is the same or different as the first-mentioned NBR elastomeric composition, and when different the second elastomeric composition comprising one or more nitrile butadiene elastomer(s) (NBR); one or more ethylene-vinyl acetate elastomer(s); and one or more PVC polymer(s).

In exemplary embodiment(s), a second elastomeric layer forms an inner layer of the hose; the PK barrier layer is disposed outwardly of the elastomeric layer; a tie layer is disposed outwardly of the PK barrier layer, wherein the tie layer is formed from the NBR elastomeric composition; a reinforcement layer disposed outwardly of the tie layer; and a cover layer disposed outwardly of the reinforcement layer.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

Use of “a” or “an” are employed in this disclosure to describe elements and components of the embodiments herein. This is done merely for convenience and to give a general sense of concepts according to the disclosure. This description should be read to include one or at least one and the singular also includes the plural unless otherwise stated.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The phrases “at least one of [A], [B] and [C];” “at least one of [A], [B] or [C];” “one or more of [A], [B] and [C]”; or “one or more of [A], [B] or [C]” are all synonymous with the phrase “and/or” and are used to mean “one, or more, or all” unless clearly indicated to the contrary. Thus, as a non-limiting example, this could mean (1) A only, (2) B only, (3) C only, (4) A and B, (5) A and C, (6) B and C, or (7) all of A, B and C. Other elements may optionally be present other than the elements specifically identified whether related or unrelated to those elements specifically identified unless clearly indicated to the contrary—e.g., by reciting a closed group of alternatives, such as via conventional “Markush grouping” by stating “selected from the group consisting of [A], [B], and [C].”

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

The example(s), if any, are for the purpose of illustrating the nature of some of the embodiment(s) and/or aspect(s) of the present disclosure and are not intended as a limitation on the scope thereof. Along these lines, such example(s) may include exemplary ingredients according to certain embodiment(s) of the present disclosure, and also may specifically exclude certain other ingredient(s) according to certain embodiment(s) of the present disclosure. Therefore, it is to be understood that the listing of certain ingredient(s) or class(es) of ingredients in the disclosure which are absent in the example(s) of the disclosure can mean an express exclusion of such ingredient(s) or class(es) of ingredients as if explicitly stated such that the inventor(s) have possession of such exclusion(s). It is understood, of course, that the absence of ingredient(s) according to certain embodiment(s) illustrated in the example(s) is not a limitation on all embodiment(s) of the disclosure, and so some embodiment(s) may include the absent ingredient(s), unless clearly indicated to the contrary.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated, and thus these values are incorporated herein by reference. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) have possession of the entire range and all points within the range, which are hereby incorporated herein by reference.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, 10%, 9%, 8%, 7%, +6%, 5%, 4%, 3%, 2%, 1%, 0.01%, or 0.0% of the stated value, as well as values intervening such stated values. When the term “about” is used in describing a value or an end-point of a range, the disclosure should be understood to include the specific value or end-point referred to.

The term weight percent in relation to a component of the composition is understood to mean weight percent of that component based on total weight (100%) of the component, unless otherwise stated. As used herein, the phrase “up to” a quantity of a component means that the quantity is present in the composition up to the specified amount, i.e., greater than zero up to the specified amount. A reference to a component being “optional” or reference to a range having a lower bound of zero weight percent (0 wt. %) or zero parts by hundred (e.g., 0 phr) means that the presence of the component in the composition is optional, i.e., the material is present in an amount or alternatively is not present in the composition.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

It is to be understood that terms such as “top,” “bottom,” “left,” “right,” “front,” “rear,” or the like may refer to an arbitrary frame of reference, rather than to the ordinary gravitational frame of reference. Likewise, spatially relative terms, such as “inner”, “adjacent”, “outer,” “beneath,” “below,” “lower,” “above,” “upper,” or the like, may be used herein for ease of description to describe one element or feature's relationship to another element(s) or feature(s) as illustrated in the figures. Spatially relative terms may be intended to encompass different orientations of the article in use or operation in addition to the orientation depicted in the figures. For example, if the article in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Terms such as first, second, third, etc. may be used herein to describe various elements, components, regions, layers and/or sections, in which it is understood that these elements, components, regions, layers and/or sections should not be limited by these terms unless stated otherwise. In addition, terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of this disclosure.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

### LIST OF REFERENCE NUMERALS (PART OF THE SPECIFICATION)

100, 200, 300, 400 Hose
102 Elastomeric layer
104 Barrier layer
106 Intermediate Layer
108, 108′ Reinforcement layer
110 Cover layer
212 Inner Tube
500, 600, 700 Article
616 Reinforcement layer

1. A multilayer hose comprising:
an NBR elastomeric layer directly bonded to a polyketone (PK) barrier layer without an intervening adhesive layer,
the NBR elastomeric layer formed from a composition comprising:
one or more nitrile butadiene elastomer(s) (NBR) in a total amount from 50 phr to 100 phr;
one or more ethylene-vinyl acetate elastomer(s) (EVM) in a total amount from 5 phr to 15 phr; and
one or more polyvinylchloride polymer(s) (PVC) in a total amount from 10 phr to 20 phr.

2. The multilayer hose according to claim 1, wherein:
the elastomeric layer exhibits bonding strength to the polyketone barrier layer of 10 lbf/in or greater when tested according to ASTM D413-98.

3. The multilayer hose according to claim 1, wherein the elastomeric layer has one or more of:
(i) retained tensile when immersed in Fuel H for 70 hours at room temperature according to ASTM D471 of 40% or more;
(ii) retained elongation when immersed in Fuel H for 70 hours at room temperature according to ASTM D471 of 50% or more;
(iii) a volume swell percentage when immersed in Fuel H for 70 hours at room temperature according to ASTM D471 of 50% or less;
the elastomeric layer exhibits bonding strength to the polyketone barrier layer of 15 lbf/in or greater, or stock tear of the elastomeric layer; and/or
the elastomeric layer has a volume swell percentage when immersed in Fuel H for 70 hours at room temperature according to ASTM D471 of about 45% or less.

4. The multilayer hose according to claim 1, wherein:
the one or more EVM(s) are present in a total amount from 10 phr to 15 phr; and/or
the one or more PVC(s) are present in a total amount from 10 phr to 15 phr.

5. The multilayer hose according to claim 1, wherein the one or more PVC(s) are fluxed with the one or more NBR(s).

6. The multilayer hose according to claim 1, wherein:
the polyketone barrier layer exhibits a permeation rate of CE10 fuel of less than 15 g/m²/day, when tested according to SAE J2665 at 25 °C and 30 in·Hg.

7. The multilayer hose according to claim 1, wherein:
the polyketone barrier layer is formed from an essentially pure aliphatic polyketone material of formula [[—CHR₁CH₂(C═O)—]ₙ[—CHR₂CH₂(C═O)—]ₘ]_{P} where R₁ and R₂ are different from each other and are independently hydrogen or a C₁-C₁₂-alkyl group, n+m=1, and p is an integer, and the two comonomers may be randomly distributed or present as blocks.

8. The multilayer hose according to claim 1, wherein:
the one or more EVM(s) have a vinyl acetate content in a range from 40% by weight of the copolymer to 90% by weight of the copolymer.

9. The multilayer hose according to claim 1, wherein:
the elastomeric composition further comprises one or more reinforcing agent(s) in a total amount from 40 phr to 125 phr, more particularly from 60 phr to 110 phr.

10. The multilayer hose according to claim 1, wherein:
the elastomeric composition has a cure effective amount of a peroxide curative system.

11. The multilayer hose according to claim 1, wherein:
the material properties of the elastomeric composition includes one or more original properties of: (i) elongation at break of greater than 70%, (ii) modulus of elasticity at 100% of greater than 500 psi; (iii) tensile strength of greater than 1,000 psi; and/or (iv) Shore A hardness in a range from 70 to 90.

12. The multilayer hose according to claim 1, wherein:
the NBR elastomeric layer forms an inner layer of the hose;
the PK barrier layer is disposed outwardly of the elastomeric layer;
a tie layer is disposed outwardly of the PK barrier layer,
a reinforcement layer disposed outwardly of the tie layer; and
a cover layer disposed outwardly of the reinforcement layer.

13. The multilayer hose according to claim 12, wherein:
the tie layer being directly bonded to the PK barrier layer without an intervening adhesive layer, and wherein the tie layer is formed from a second NBR elastomeric composition which is the same or different as the first-mentioned NBR elastomeric composition, and when different the second elastomeric composition comprising one or more nitrile butadiene elastomer(s) (NBR); one or more ethylene-vinyl acetate elastomer(s); and one or more PVC polymer(s).

14. The multilayer hose according to claim 1, wherein:
a second elastomeric layer forms an inner layer of the hose;
the PK barrier layer is disposed outwardly of the elastomeric layer;
a tie layer is disposed outwardly of the PK barrier layer, wherein the tie layer is formed from the NBR elastomeric composition;
a reinforcement layer disposed outwardly of the tie layer; and
a cover layer disposed outwardly of the reinforcement layer.

15. A method of manufacturing the hose according to claim 1, comprising:
mixing the ingredients of the elastomeric composition;
extruding the elastomeric composition as a layer of the hose;
extruding the PK barrier layer;
wherein the elastomeric layer and the PK barrier layer are in direct contact without an intervening adhesive layer;
crosslinking the elastomeric layer and directly bonding the elastomeric layer to the PK barrier layer.

16-20. (canceled)
